(19) United States
(12) Patent Application Publication
(10) Pub. No.: US 2020/0052392 A1
(43) Pub. Date: Feb. 13, 2020

(54) VEHICLE ROOF ANTENNA

(71) Applicant: Antenum LLC, Merrimack, NH (US)

(72) Inventors: James D. Logan, Candia, NH (US); John T. Apostolos, Lyndeborough, NH (US); William Mouyos, Windham, NH (US); Sean D. Hallinan, Merrimack, NH (US)

(21) Appl. No.: 16/536,880

(22) Filed: Aug. 9, 2019

Related U.S. Application Data
(60) Provisional application No. 62/716,728, filed on Aug. 9, 2018.
(60) Provisional application No. 62/729,558, filed on Sep. 11, 2018.
(60) Provisional application No. 62/731,477, filed on Sep. 14, 2018.

(51) Int. Cl. H01Q 1/32; H01Q 21/06

(52) U.S. Cl. CPC H01Q 1/3275; H01Q 1/3233; H01Q 21/067

(57) ABSTRACT

A suite of antennas integrated into a vehicle roll bar adjacent to a glass roof that allows for the sending and receiving of signals, which replaces antennas that are commonly placed on the roof of the vehicle, side view mirrors, or near the rear-view mirror at the front on the vehicle.

### CROSS REFERENCE TO RELATED APPLICATIONS

This patent claims priority to co-pending U.S. Provisional Application entitled “Vehicle Rollbar Antenna System”, Ser. No. 62/716,728 filed Aug. 9, 2018, and U.S. Provisional Application entitled “Vehicle Rollbar Antenna System”, Ser. No. 62/729,558 filed Sep. 11, 2018 and U.S. Provisional Application entitled “Vehicle Rollbar Antenna System”, Ser. No. 62/731,477 filed Sep. 14, 2018, the entire contents of each of which are hereby incorporated by reference.

### BACKGROUND

### Technical Field

This patent relates to the integration of a suite of antennas in a vehicle roof (or roll bar) and/or the associated trim pieces.

### Description of the Related Art

Antennas have been embedded in certain portions of the vehicle. One common approach implements the antenna as a conductive wire trace deposited onto a window. However, window antennas also have drawbacks, such as reduced visibility out of the window, directional sensitivity, and degradation due to sun exposure over time. Alternatively, shark fin antennas have come into use since the late 1990's. These are roof mounted assemblies, approximately 6 inches or so in length, encased in an aerodynamic or other visually pleasing housing. However, shark fins also protrude from the vehicle body; their shortened length sometimes tends to compromise reception. The Tesla Model S, and other vehicles, currently house antennas in the car's side view mirrors.

### SUMMARY

A suite of antennas is integrated into the roof of a vehicle, such as so-called B-header of a vehicle containing one or more glass roof pieces. Radio frequency signals are coupled between one or more transceivers located in the interior of the vehicle to the outside of the vehicle. A variety of radiating antenna elements may be utilized in order to achieve full azimuth coverage for a variety of radio frequency bands. This suite of antennas located in the header replaces antennas that are commonly placed on top of the roof of the vehicle, or side view mirrors, or near the inside rear-view mirror, or at the front on the vehicle. The suite of antennas, positioned in a rigid, low-visibility assembly located on the top of the vehicle, near to but not on any glass roof pieces, are capable of sending and receiving signals across a wide frequency range with limited interference.

### BRIEF DESCRIPTION OF THE DRAWINGS

FIG. 1 is a drawing of the interior of a Tesla vehicle looking upwards towards the roof, showing the B Header area and associated trim.

FIG. 2 is a drawing of one example antenna layout.

FIG. 3A is a drawing of an end fire antenna array configuration.

FIG. 3B is a drawing of a broadside antenna array configuration.

FIG. 3C is a drawing of another embodiment of either the a endfire or broadside antenna array where the elements are folded over a portion of the header.

FIG. 4 is a drawing of a quadrature hybrid used to feed the GPS antenna of FIG. 5.

FIG. 5 is a drawing of an example location of a GPS Antenna.

FIG. 6 is a drawing of a top view of the three trim pieces and an alternate arrangement of the antenna elements.

FIG. 7 is a drawing of a geometry of one example Antenna Element that follows the curvature of a trim piece junction.

FIG. 8 is a drawing of an alternative embodiment for the end fire elements.

FIG. 9 is a drawing of a vehicle roof structure.

FIG. 10 is a drawing of the A-header and B-header.

### DETAILED DESCRIPTION OF PREFERRED EMBODIMENTS

Described herein are a system, method, and apparatus for integration of a suite of Antennas in a vehicle roll bar and associated trim of a vehicle. The suite of antennas, according to the below description, allows transmission and reception of radio signals through the glass of a vehicle, such as nearby moon roof(s) and/or window pieces.

### I. ANTENNA INTEGRATION

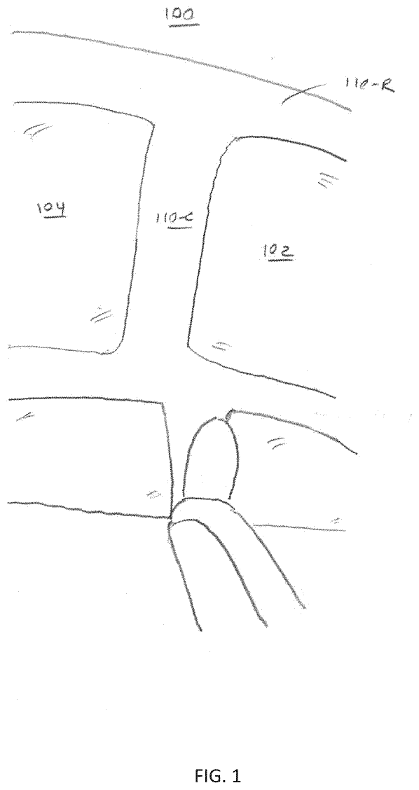

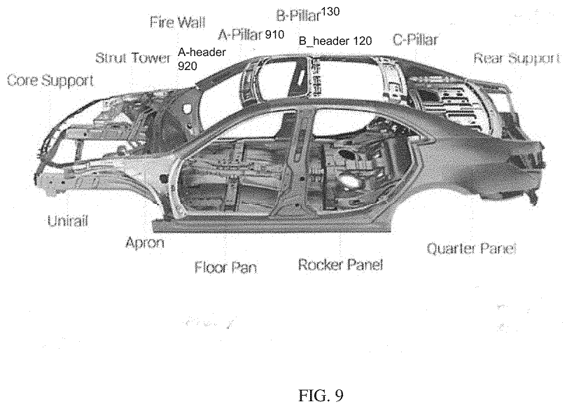

FIG. 1 shows an inside view of a Tesla vehicle including the so-called B header region 100 (also referred to as a “rollbar”), glass roof pieces 102, 104 and associated trim pieces 110-L, 110-C, 110-R (referred to collectively herein as trim pieces 110). FIG. 9 is a cut away view of the Tesla showing the metallic structural parts, including the B-header 120 disposed longitudinally between the generally vertical B-pillars 130, the longitudinal A-header 910 forward of the B-header, etc. The B header is a metallic structure while the trim pieces 110 are typically composed of dielectric material such as plastic or fabric.

Integration of a suite of antennas into the B header 120 and associated trim 110 depends upon the ability to use the B header metallic structure as part of the antenna array, namely as a functioning back screen to insure the distribution of the power radiated over a 360 degree azimuthal field of regard. The desired elevation coverage is usually in range of a the 0 to 30-degree field of regard.

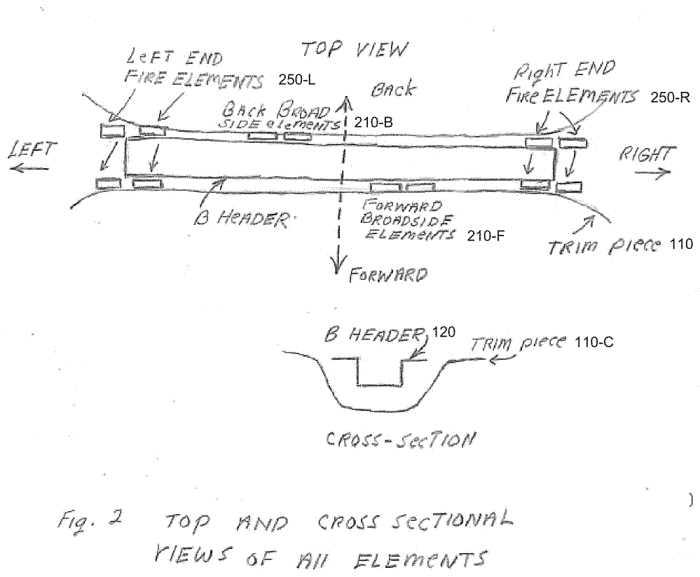

An example layout using four groups of two element antenna arrays is shown in the top view of the B header and the trim piece in FIG. 2.

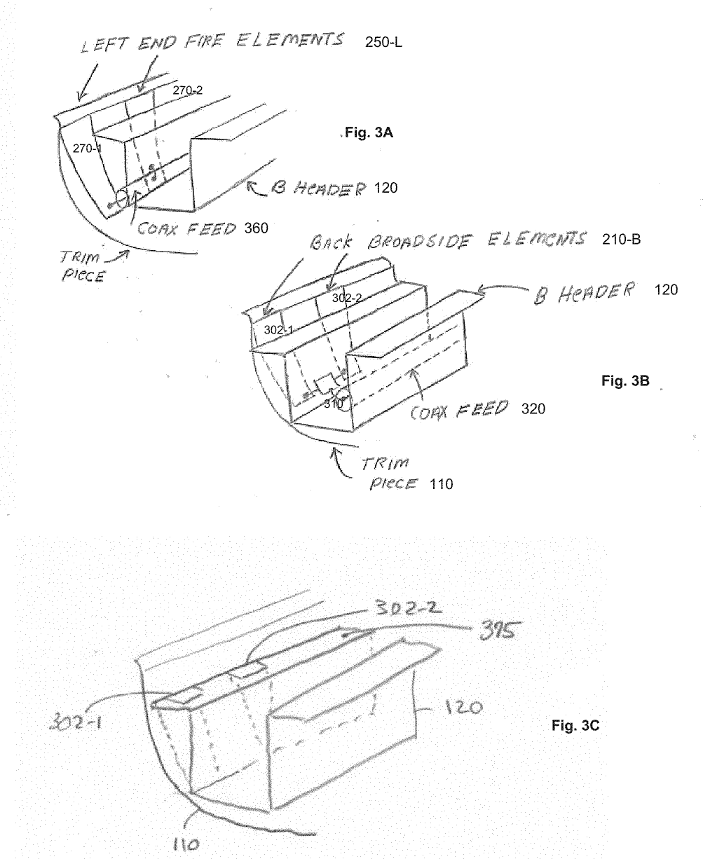

Coverage in the forward and back directions is provided by two sets of broadside two element arrays 210-B, 210-F. As shown in FIG. 3B, a two-element broadside array using monopole-like elements 302-1, 302-2 spaced about three inches and fed in phase through a splitter 310 provides coverage towards the back of the vehicle, while a similar set of elements (shown only in FIG. 2) on the forward side provides coverage to the front. Separate coax feeds 320 are used to feed the front and back arrays respectively. The metallic B header 120 is used as a reflecting screen with the outer conductors of the coax connected to the B header itself. The effective length of the B header as a reflector is obtained by adding the total cross-sectional path of the header. For this particular B header that length is about 7 inches, which is an indication that the back screen should be active from 698 to 3800 MHz. The driven monopole elements 302-1, 302-2 are each about three inches in length which is close to ¼ wavelength at 698 MHz. The ¼ wavelength height coupled with the width of the element should enable efficient operation for all LTE bands. Estimated gain at 698 MHz should be 2 dbi on the horizon. Estimated gain above 1500 MHz should be 4 dbi on the horizon. Beamwidths should be in the 90 to 100 degree range.

Coverage for the right and left directions is provided by end fire elements 250-L, 250-R as shown in FIGS. 2 and 3A. A more detailed view of the left coverage endfire array 250-L is shown in FIG. 3A. The two elements 270-1, 270-2 in each pair are fed out of phase. The element 270-1 nearest the edge of the B header 120 acts as the radiator, while the second element 270-2 is used to couple to the B header 120, which acts a reflecting structure. As seen in FIG. 2, there are two sets 250-L, 250-R of endfire elements, one on each of the left and right ends of the B header. These two sets are fed in phase to insure sufficient gain to the left and right side of the vehicle. Gain on the horizon is expected to be about 1 dbi at 698 MHz, while above 1500 MHz gain should be about 3 dbi.

Although the broadside and endfire arrays are shown here as each including two radiating elements, it should be understood that additional elements may also be included in each array.

FIG. 3C is another possible arrangement where the radiating elements 270 and/or 302 are folded to overlap, at least partially (or perhaps fully), with a peripheral flange portion of the B header 120. The folded over portion of the elements 270, 302 may be capacitively coupled to the B header here. This arrangement may be preferred where higher efficiency is desired at the low end of the operating frequency band(s) and/or an improved radiation pattern in the elevation plane. More details of such elements are found in U.S. Pat. No. 10,135,122 issued Nov. 20, 2018 entitled “Super Directive Arrays of Volumetric Antenna Elements for Wireless Device Applications”, the entire contents of which are hereby incorporated by reference.

### II. ANTENNA COMPOSITION

a. End Fire Antennas

The End-Fire arrays 250-L, 250-R may each be a super directive end fire array of volumetric patch antennas conforming to the periphery of the header trim pieces, or where cylindrical array elements are disposed within the interior of the device. Such End-Fire Antennas are fully described in US Patent Application No. 2018/0151947, incorporated fully herein by reference.

b. Broadside Antennas

As shown in FIG. 3, a two-element broadside array 250-B using monopole-like elements spaced about three inches and fed in phase through a splitter provides coverage to the back, while a similar set of elements on the forward side (shown in FIG. 2) provides coverage to the front.

a. GPS Antenna

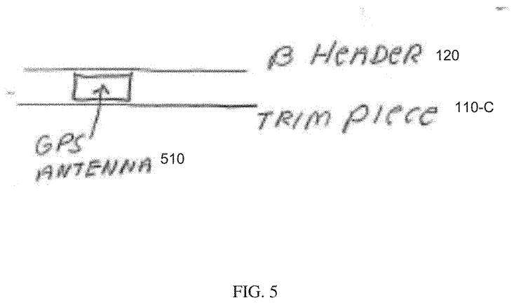

A GPS antenna element may also be embedded in the same B-header to replace a separate planar antenna located elsewhere on the vehicle. One example GPS Antenna 510, as shown in FIG. 5, may be located in between the B Header 120 and trim piece 110-C. This GPS antenna 510 may include wideband volumetric antenna element(s) that cover the L1, L2, and L5 bands, such as two or more pairs of cross coupled elements. All three bands are at the same phase center. Such a GPS antenna 510 can provide circular polarization. A suitable GPS antenna 510 is more fully described in U.S. Patent Application 2016/15362988, entitled “Super Directive Array Of Volumetric Antenna Elements”, and is incorporated herein by reference.

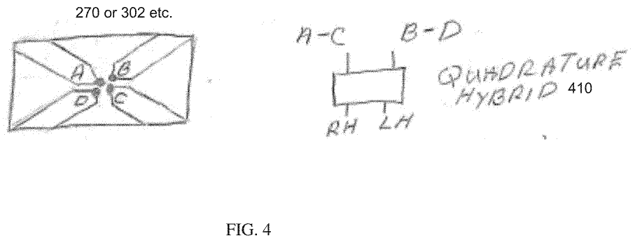

A feed for the GPS antenna 510 may include the quadrature hybrid arrangement shown in FIG. 4.

### III. ALTERNATIVE EMBODIMENTS

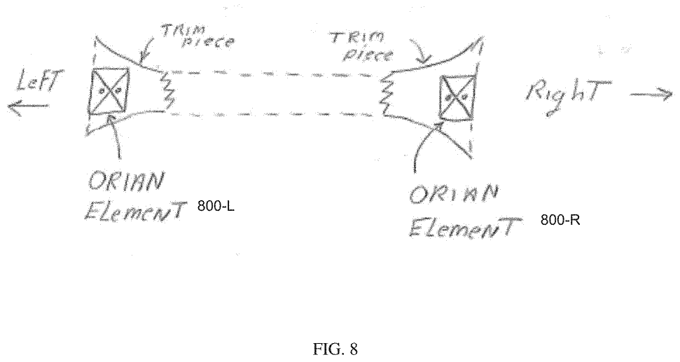

In another embodiment, the left end and right end fire elements shown in FIGS. 2 and 3 comprise orientation independent (ORIAN) Elements 800-L, 800-R shown in FIG. 8. Examples of such ORIAN Elements are further described in U.S. Patent Application No. 2017/62454178 and are fully incorporated herein by reference.

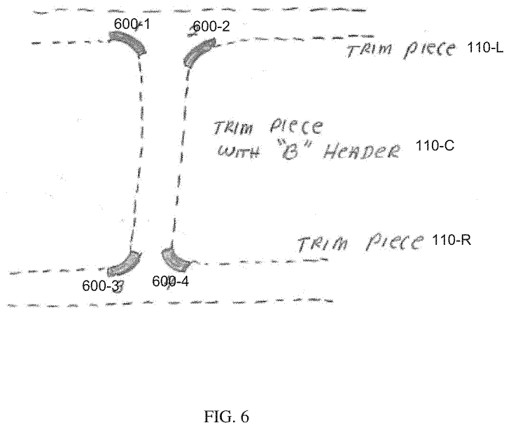

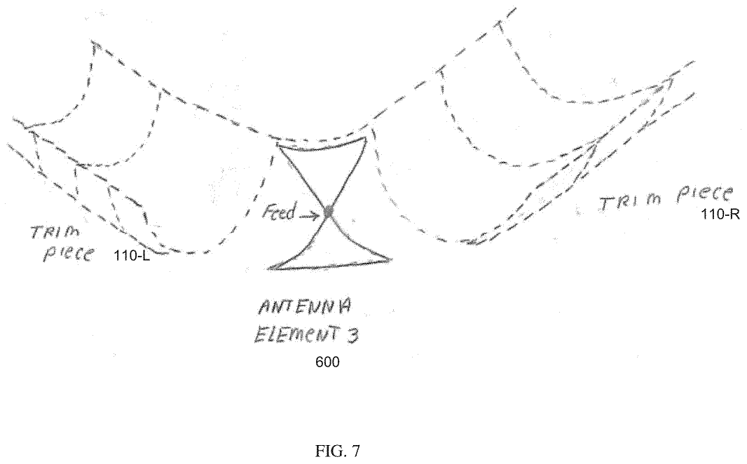

In another embodiment, the three connected trim pieces 110-L, 100-C, 100-R seen in FIG. 1, constitute a structure 650 associated with a four-element array. This arrangement is shown in FIG. 6, which is a top view of the three trim pieces 110 with element 600-1, 600-2, 600-3, 600-4 located on the four “corners” where the rollbar (B-pillar 120) meets the sides of the roof. The Elements may be vertically polarized, cross coupled Bow Ties designed to work from 600-3800 MHz. The Elements may be glued to the dielectric trim pieces and feed as shown in FIG. 7 and driven using the feed of FIG. 4 or other feeds. Example Bow Tie Antenna Elements, as shown in FIG. 7, may each follow the curvature of the corresponding junction between two trim pieces.

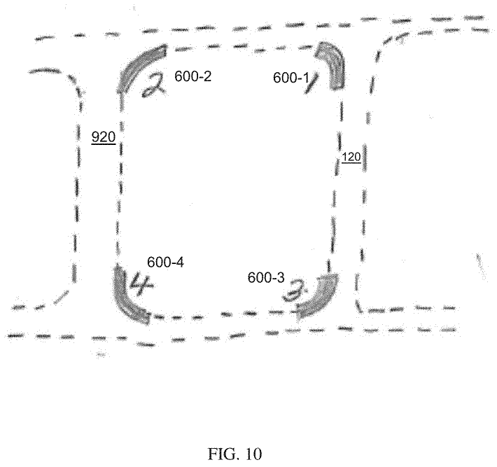

In another embodiment, in addition to the B-Header 120 (B-Pillars 130), the area around the roof of a vehicle may include an A Pillar 910 (A-Header 920) and a C-Pillar as shown in FIG. 9. A method to increase the isolation (for 4×4 MIMO) between elements involves transferring Antennas 600-2 and 600-4, as originally shown in FIG. 6, to a different location adjacent the A-Header shown in FIG. 10. This arrangement may provide improved performance in some conditions.

a. 2×2 MIMO Applications

Implementation of 2×2 MIMO on the configuration of FIG. 10 involves feeding pairs 600-2, 600-3 either in phase, out of phase, or in quadrature, providing one MIMO input; with 600-1 and 600-4, similarly fed, providing the other MIMO input.

In another embodiment the FIG. 6 configuration utilizing pairs 600-1, 600-2 and 600-3, 600-4 as above could also provide 2×2 MIMO.

The above description of the embodiments, alternative embodiments, and specific examples are given by way of illustration and should not be viewed as limiting. Further, many changes and modifications within the scope of the present embodiments may be made without departing from the spirit thereof, and this patent is intended to include such changes and modifications.

1. An antenna structure for use in a vehicle comprising:
a longitudinal metallic header, forming a structure component intended to be disposed near a roof of the vehicle;
at least one trim piece, disposed adjacent the metallic header; and
at least two pairs of radiative antenna elements, each of the two pairs of elements disposed in a fixed position between the metallic header and the trim piece;

2. The apparatus of claim 1 wherein the at least two pairs of antenna elements include broadside elements.

3. The apparatus of claim 1 wherein the at least two pairs of antenna elements include end fire elements.

4. The apparatus of claim 1 wherein at least one of antenna elements are disposed at an end of the header.

5. The apparatus of claim 1 additionally comprising at least two trim pieces, and the antenna elements are disposed adjacent a junction of the two trim pieces.

6. The apparatus of claim 1 wherein at least one of the antenna elements is a GPS element.

7. The apparatus of claim 1 wherein at least one of the antenna elements is an orientation independent element.

8. The apparatus of claim 1 wherein at least one of the antenna elements is a cross coupled bow tie element.

9. The apparatus of claim 1 where the metallic header has a peripheral flange, and wherein at least one of the antenna elements overlaps a portion of the header.
